(19) United States
(12) Patent Application Publication
(10) Pub. No.: US 2026/0175999 A1
(43) Pub. Date: Jun. 25, 2026

(54) SYSTEM AND METHOD FOR SURFACE INSPECTION OF A COMPOSITE PART OF AN AIRCRAFT

(71) Applicant: Airbus SAS, BLAGNAC (FR)

(72) Inventors: Mohamed SAYEH, TAUFKIRCHEN (DE); Liu MENG, TAUFKIRCHEN (DE)

(21) Appl. No.: 19/423,273

(22) Filed: Dec. 17, 2025

(30) Foreign Application Priority Data
Dec. 19, 2024 (EP) 24221592.9

(51) Int. Cl. B64F 5/60; G01N 21/88

(52) U.S. Cl. CPC B64F 5/60; G01N 21/8806; G01N 21/8851; G01N 2021/8816

(57) ABSTRACT

A system and a method for surface inspection of a composite part of an aircraft with a first illumination unit positioned in front of a surface of a composite part to illuminate that surface with evenly distributed light, and a second illumination unit to illuminate the surface with light hitting the surface at an angle from different sides. Both illumination units are configured to alternately illuminate the surface. A polarization camera unit generates image data of the surface while the surface is alternately illuminated by the illumination units. A processor unit processes the image data, detects defects on the surface of the composite part, and determines the directions of fibers within the composite part from the image data.

### CROSS-REFERENCES TO RELATED APPLICATIONS

This application claims the benefit of European Patent Application Number 24 221 592.9 filed on Dec. 19, 2024, the entire disclosure of which is incorporated herein by way of reference.

### FIELD OF THE INVENTION

The invention relates to a system for surface inspection of a composite part of an aircraft. Further, the invention relates to a method for surface inspection of a composite part of an aircraft. In particular, the composite part to be inspected comprises or is made of a fiber reinforced material, in particular CFRP (Carbon Fiber Reinforced Polymers).

### BACKGROUND OF THE INVENTION

The invention is in particular applicable to the inspection of CRFP parts of an aircraft, and comprises e.g. cured surface inspection, cured flap panel surface inspection, cured CFRP stiffeners surface inspection, and primer-painted CFRP parts surface inspection.

Inspecting the surface of fiber reinforced composite parts like CFRP parts is necessary in order to detect defects on the surface and to eliminate them. The CFRP parts are typically very shiny and specular reflective. The defects are quite often very small so that they can hardly be seen with the naked eye. Or they are half hidden under reflective surfaces that require special angles to see clearly the structure. Sometimes, changing viewing angles on a part with complex geometry and surface texture is not ergonomic for human operators.

Defects may also occur within the composite part. For example, areas of the composite part in which the reinforcing fibers have an orientation which deviates from the desired orientation according to the specification need to be detected. Such defects would lead to a reduced strength of the composite part. Typically, these kinds of deviations can impact the part from the interior towards surface. Namely, fiber undulation on top of the surface is a strong indicator of interior undulation. Meanwhile, there is no effective automation method explicitly for interior undulation. Therefore, checking the part from outside is desired and optimal.

The inspection of composite parts must be performed on both middle and very large scale. For example, surfaces from 2 m² to 20 m² and even more than 800 m² in case of larger aircrafts need to be inspected. The time needed for inspecting the parts is an important cost factor. However, the surface inspection needs to be performed with a very high accuracy, typically in the range between 0.05 mm and 5 mm, in order to detect the defects for being able to eliminate them.

It is an object of the invention to provide a system and a method for inspecting surfaces of composite parts of an aircraft with high accuracy while reducing the time needed for aircraft surface inspection and the related costs.

### SUMMARY OF THE INVENTION

The object may be solved by a system for surface inspection of a composite part of an aircraft, comprising: a first illumination unit configured to be positioned in front of a surface of a composite part to be inspected and to illuminate that surface with evenly distributed light, a second illumination unit configured to illuminate the surface with light hitting the surface at an angle from different sides, wherein both illumination units are configured to alternately illuminate the surface; a polarization camera unit configured to generate image data of the surface while the surface is alternately illuminated by the first and second illumination unit; and a processor unit configured to process the image data and to detect defects on the surface of the composite part, and to determine the directions of fibers within the composite part from the image data.

Preferably, the first illumination unit comprises a base area light source and a top area light source, wherein the base area light source comprises a viewing window and the top area light source is arranged behind that viewing window, and wherein a beam splitter unit is arranged between the viewing window and the top area light source, to direct the light reflected from the surface to be inspected to the polarization camera unit.

The view hole is, e.g., formed by a through hole within the base area light source.

Preferably, the base area light source and the top area light source form together a light emitting area which completely covers the surface to be inspected within the field of view of the polarization camera unit.

Preferably, the first illumination unit comprises a number of light sources, which eliminate the reflection of the system, especially of a through hole or viewing window, being captured in the image.

Preferably, the light emitting area extends in two parallel planes which are preferably arranged one above the other, each forming a flat light-emitting surface for illuminating the surface to be inspected.

Preferably, the second illumination unit comprises a number of light sources, which are elongated and/or formed as light-emitting bars.

Preferably, the second illumination unit comprises a number of light sources which are arranged at different sides or edges of the first illumination unit.

Preferably, the second illumination unit comprises a number of light sources which are arranged at four sides or edges of or circularly around the first illumination unit.

Preferably, the second illumination unit comprises a number of light sources which extend in a direction parallel to the surface of the composite part during its inspection.

Preferably, the polarization camera unit comprises a matrix polarization camera.

The polarization camera unit is preferably configured to capture images with a minimum of 4 directions of linear polarizations.

Preferably, the beam splitter unit comprises or is configured as a non-polarizing, semi-transparent beam splitter.

In particular, the beam splitter unit allows the camera unit to be positioned on a side of the arrangement of illumination units. In this way, the system is even more compact.

Preferably, the first illumination unit and/or the second illumination unit are configured to generate amber light.

Preferably, the processor unit is configured to classify the defects according to their criticality and/or to generate a link from the image of the defects to their physical location.

According to another aspect of the invention, the invention provides a method for surface inspection of a composite part of an aircraft, comprising the steps: Alternately illuminating a surface of a composite part to be inspected with evenly distributed light generated by a first illumination unit and with light hitting the surface at an angle from different sides generated by a second illumination unit; Generating image data of the surface with a polarization camera unit while the surface is alternately illuminated by the first illumination unit only and by the second illumination unit only; and processing the image data by a processor unit which detects defects on the surface of the composite part and determines the directions of fibers within the composite part from the image data.

Preferably, the polarization camera unit captures images of the surface of the composite part through a viewing window provided in a base area light source of the first illumination unit and via a beam splitter unit arranged between the viewing window and a top area light source of the first illumination unit.

Preferably, the surface to be inspected within the field of view of the polarization camera unit is completely covered by a light emitting area which is formed by the first illumination unit and frontally illuminating the surface.

Preferably, the top area light source is arranged behind the viewing window as seen from the surface to be inspected so that the base area light source and the top area light source together completely cover the surface to be inspected with the evenly distributed light.

Preferably, the processor unit classifies the defects on the surface of the composite part according to their criticality and generates links from the image data of the defects to their physical locations.

Preferably, the processor unit determines the directions of the fibers within the composite part by analyzing the polarization directions of the light hitting the surface at an angle from different sides and reflected to the polarization camera unit.

Preferably, the system according to the invention is used in the method.

With the system and the method according to the invention, in particular defects on the surface of CFRP parts can be detected. The parts are typically very shiny and specular reflective, but also dark. The system can detect e.g. scratches, excess resin, foreign objects, dents, imprints, flaking areas, wrinkles, gaps, discoloration, contamination, protruding fibers, ground/penetrated layers, porosity, lack of resin, and undulations. In addition, the angle of surface carbon fibers can be measured.

The system comprises, e.g., two major parts: a polarization camera and a light system. The light system comprises, e.g., three components: a base area light source formed by the first illumination unit, a top area light source formed by the second illumination unit, and a non-polarizing semi-transparent beam-splitter.

The invention overcomes in particular the difficulty to detect defects on the very shiny, highly reflective but often very dark surface of composite parts, which makes it very difficult to acquire image data of the surface. The system and method lights-up the surface, while blind spot reflections from the surface are not captured and thus, they do not disturb the image of the surface. Thus, a very clear crisp image is generated without disturbing reflections.

The polarization camera detects in particular the carbon fibers and their orientation due to the polarization of the light when it is reflected by the carbon fibers. The carbon fibers polarize the light in a direction according to their orientation. This is used to determine where the fibers are aligned and in which direction. The system and method according to the invention detects areas where the fibers are not in the direction as designed or required.

The polarization angle is measured or detected by the polarization camera and calculated by a software module from the image data generated by the polarization camera. Preferably, the polarization camera captures four directions of polarization angles.

Preferably, the surface is illuminated with amber light, i.e., preferably in a range of about 590 nm. This provides the best quality. However, other wavelengths can be used as well and may be advantageous depending on the purpose like, e.g., blue or green light. Generally, wavelengths between 830 nm and about 1000 nm are preferred as well.

The system according to the invention provides a clean illumination in the whole field of view of the polarization camera.

Many different types of defects can be detected by the system and the method. For example, 16 types of defects including fiber defects have been identified. The number of types may vary depending on the specific inspection purposes. The processing unit is configured to determine the defects and to classify the defects. For example, the geometry of each defect is calculated and the type of each defect is determined from the image data. Preferably, each defect is classified according to its criticality, e.g., with the help of a comparison database. Preferably, this is done by a computer program.

A large variety of different types of defects including fiber related defects can be detected by the system in only one measurement run. It is not necessary to change the system in order to detect the defects.

### BRIEF DESCRIPTION OF THE DRAWINGS

Embodiments of the invention are described in more detail with reference to the accompanying drawings, in which

FIG. 1 depicts a schematic view of a system for surface inspection of a composite part according to a preferred embodiment of the invention;

FIG. 2 depicts a schematic side view of the system shown in FIG. 1 during a first illumination mode;

FIG. 3 depicts a schematic side view of the system shown in FIG. 1 during a second illumination mode;

FIG. 4 depicts a flow chart of a method for surface inspection method according to a preferred example of the invention; and

FIG. 5 depicts a cross-sectional view of an example of a composite part inspected using the system and method according to the invention

### DETAILED DESCRIPTION OF THE PREFERRED EMBODIMENTS

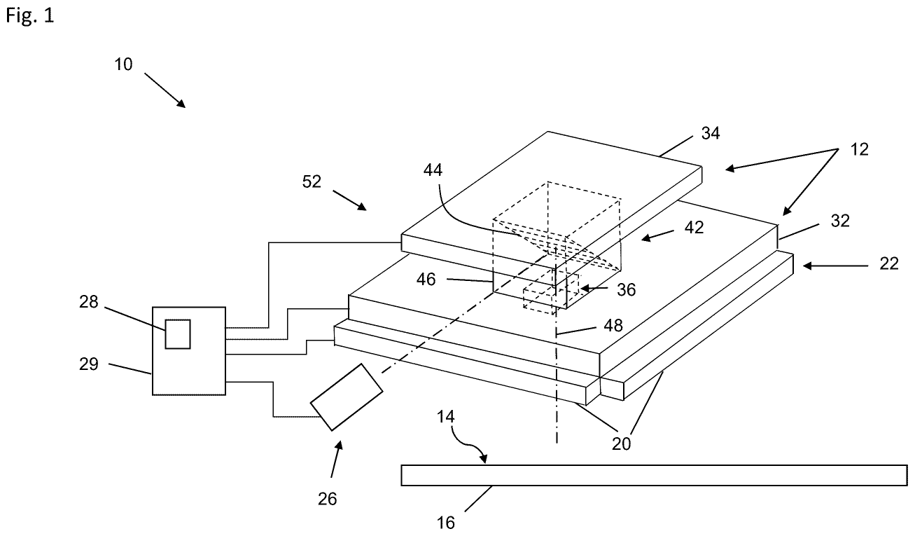

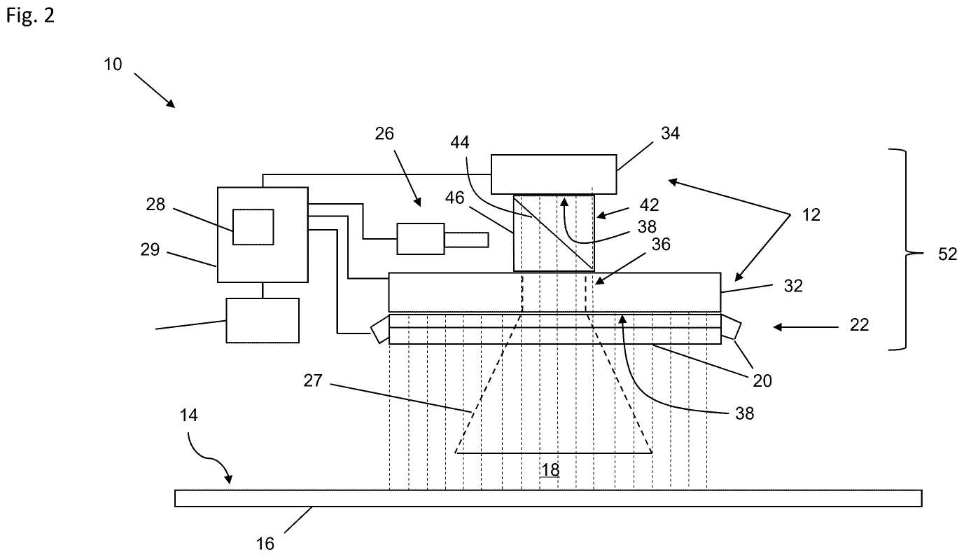

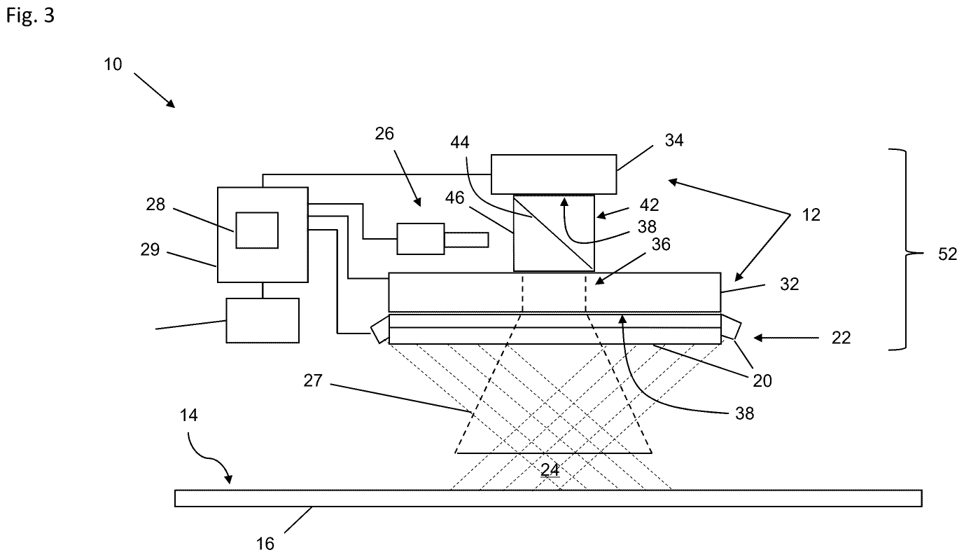

As depicted in FIGS. 1, 2 and 3, a surface inspection system 10 according to a preferred embodiment of the invention comprises a first illumination unit 12, which is configured to be positioned in front of a surface 14 of a composite part 16 to be inspected and to illuminate the surface 14 with evenly distributed light 18 in a first illumination mode (see FIG. 2). A second illumination unit 22 is configured to illuminate the surface 14 with oblique incident light 24 hitting the surface 14 at an angle from different sides in a second illumination mode (see FIG. 3). Both illumination units are configured to alternately illuminate the surface 14.

A polarization camera unit 26 is configured to capture images of the surface 14 and to generate image data while the surface 14 is alternately illuminated by first illumination unit 12 and by second illumination unit 22.

A processor unit 28 is configured to process the image data and to detect defects on the surface 14 of composite part 16. It determines the directions of fibers within the composite part 16 from the image data with a computer program.

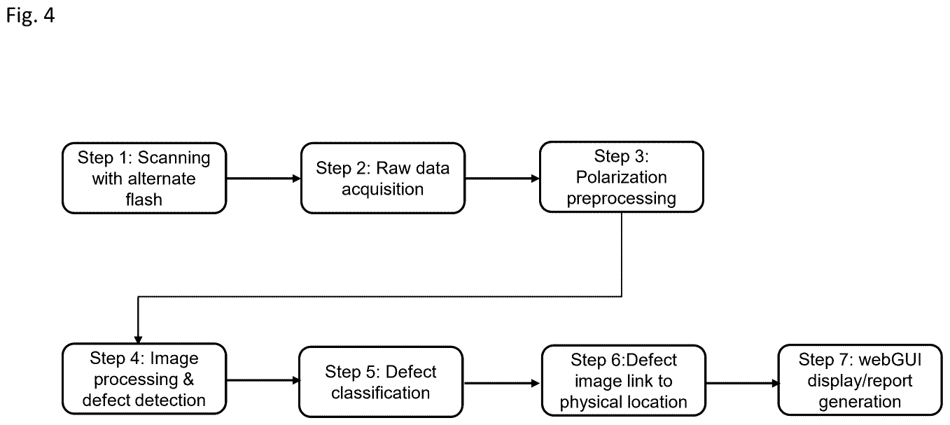

The first illumination unit 12 comprises a base area light source 32, and a top area light source 34. The base area light source 32 comprises a viewing window 36 formed as a through hole. The top area light source 34 is arranged behind that viewing window 36 as seen from surface 14 to be inspected. In this way, first base area light source 32 and the top area light source 34 form together a light emitting area 38 which completely covers the surface 14 within in the field of view 27 of polarization camera unit 26 (see FIGS. 3 and 4).

The light emitting area 38 formed by base area light source 32 and top area light source 34 extends in 2 levels, which are aligned parallel to each other, each forming a flat or 2-dimensional surface for illuminating the surface 14 to be inspected.

The second illumination 22 unit comprises a number of elongated light sources 20, which are formed as light-emitting bars. They are arranged at the different sides or edges of the base area light source 32, i.e., they are arranged at four sides or edges of the first illumination unit 22 and preferably extend in a direction parallel to the surface 14 of the composite part 16 when it is inspected.

During operation, the first illumination unit 12 and/or the second illumination unit 22 generate amber light in the embodiment shown here.

A beam splitter unit 42 is arranged between viewing window 36 and top area light source 34, to direct the light 18, 24 generated by illumination units 12, 22 and reflected from the surface 14 to the polarization camera unit 26. The beam splitter unit 42 comprises a non-polarizing, semi-transparent beam splitter 44 which is preferably arranged in a chamber 46 made of a non-transparent material, preferably of black color. In this way, double reflections of system interior being captured by the camera are prevented.

First illumination unit 12, second illumination unit 22 and beam splitter unit 42 form a light system 52 which is formed as one entity. It is configured to be moved together with polarization camera unit 26 for scanning the surface 14 of the composite part 16.

The beam splitter unit 42 redirects a part of the light path 48 to the polarization camera unit 26 arranged at one side of the light system 52.

The polarization camera unit 26 comprises a polarization camera and, e.g., a lens. It is designed as a matrix polarization camera configured to capture images in four directions of polarization.

The light system 52 and the polarization camera unit 26 form an end effector which is configured to be mounted on a robot arm which is not shown in the figures, in order to be moved relative to the surface 14 for scanning it.

The processor unit 28 is configured to classify the defects according to their criticality and to generate a link from the image of the defects to their physical locations. It is part of a control and evaluation unit 29 to which the illumination units 12, 22 and the camera unit 26 are connected in order to be controlled.

With reference to FIG. 4, a preferred example of a method for surface inspection is described now. In this example, the inspection system 10 described above is used.

The surface 14 of a composite part 16 is scanned with polarization camera unit 26 and with first and second illumination units 12, 22.

During the scan, first and second illumination units 12, 22 generate alternating flashes illuminating surface 14. Thus, the surface 14 is alternately illuminated with evenly distributed light 18 only, which is generated by first illumination unit 12, and with light 24 hitting the surface at an angle from different sides only, which is generated by a second illumination unit 22.

While the surface 14 is alternately illuminated by the first illumination unit 12 and by the second illumination unit 22, polarization camera unit 26 captures images of the surface 14 and generates image data of the surface 14. The image data is acquired as raw data and preprocessed, wherein the polarization directions of the light reflected from surface 14 is determined. To determine the polarization directions, the image data representing surface 14 when illuminated with the oblique incident light 24 emitted from second illumination unit 22 and forming a dark field illumination is used.

For generating the image data, polarization camera unit 26 captures images of the surface 14 the composite part 16 through viewing window 36 provided in base area light source 32 of the first illumination unit 12 and via beam splitter unit 44 arranged between the viewing window 36 and top area light source 34 of the first illumination unit 12.

When the image data is generated, the surface 14 to be inspected which is within the field of view 27 of camera unit 26 is completely covered by light emitting area 38 formed by the first illumination unit 12 and frontally illuminating the surface 14 as a bright field illumination.

The image data is processed by processor unit 28 which detects defects on the surface 14 of composite part 16 including defects relating to the fibers of the composite part 16. In this step, the directions of fibers within the composite part 16 are and the angles of their directions or orientations are determined and calculated from the image data, i.e., they are measured.

Further, the defects are classified according to their criticality, and links from the image data of the defects to their physical locations are generated by processor unit 28.

A report of the results of the surface inspection is generated, which is presented on a display or in written form. It comprises the details of the defects, their physical locations, and their classification including their individual criticality.

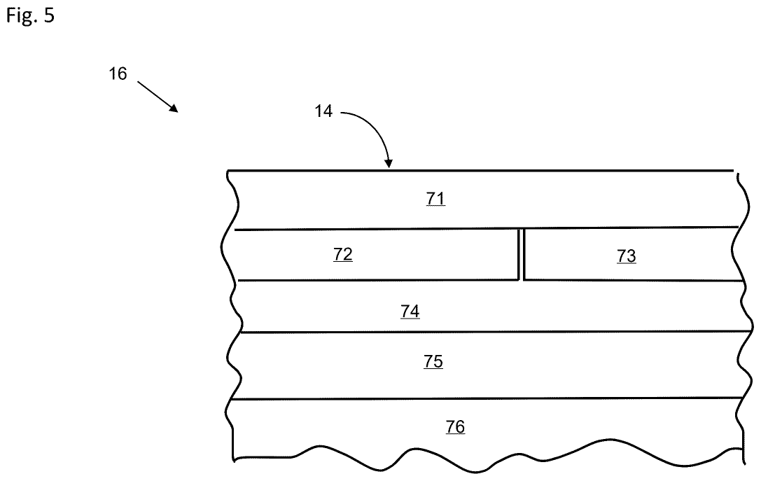

As shown in FIG. 5, the system and method described above can in particular measure the orientation of fibers within carbon fiber layer 73 and partially the orientation of fibers within carbon fiber layer 74. In case that carbon fiber layers are occluded by upper non-transparent or non-translucent layers, like carbon fiber layers 75, 76 which may be occluded by carbon fiber layers 73, 74 in this example, the orientation of carbon fibers in the occluded layers 75, 76 cannot be measured. In general, the orientation of carbon fibers can be measured if they are not occluded by upper layers, i.e., layers which are closer to the inspected surface 14.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### List of Reference Signs

10 surface inspection system
12 a first illumination unit
14 surface to be inspected
16 composite part
18 evenly distributed light
20 elongated light sources/light-emitting bars
22 second illumination unit
24 oblique incident light
26 polarization camera unit
27 field of view
28 processor unit
29 control and evaluation unit
32 base area light source
34 top area light source
36 viewing window
38 light emitting area
42 beam splitter unit
44 non-polarizing, semi-transparent beam splitter
46 chamber
48 light path
52 light system
71 resin film
72 glass layer
73 carbon layer 1
74 carbon layer 2
75 carbon layer 3

Claimed is:

1. A system for surface inspection of a composite part of an aircraft, the system comprising:
a first illumination unit configured to be positioned in front of a surface of a composite part to be inspected and to illuminate that surface with evenly distributed light;
a second illumination unit configured to illuminate the surface with light hitting the surface at an angle from different sides, wherein the first illumination unit and the second illumination unit are configured to alternately illuminate the surface;
a polarization camera unit configured to generate image data of the surface while the surface is illuminated by the first illumination unit and the second illumination unit; and,
a processor unit configured to process the image data, to detect defects on the surface of the composite part, and to determine directions of fibers provided within the composite part from the image data.

2. The system according to claim 1, wherein the first illumination unit comprises a base area light source and a top area light source,
wherein the base area light source comprises a viewing window and the top area light source is arranged behind the viewing window, and
wherein a beam splitter unit is arranged between the viewing window and the top area light source to direct the light reflected from the surface to be inspected to the polarization camera unit.

3. The system according to claim 2, wherein the first illumination unit and the viewing window are configured to minimize a reflection of the viewing window from the surface.

4. The system according to claim 2, wherein the base area light source and the top area light source together form a light emitting area which completely covers the surface to be inspected within a field of view of the polarization camera unit.

5. The system according to claim 4, wherein the light emitting area extends in two parallel planes arranged one above the other, each forming a flat light-emitting surface for illuminating the surface to be inspected.

6. The system according to claim 1, wherein the second illumination unit comprises a number of light sources which
are elongated as light-emitting bars;
are formed as light-emitting bars;
are arranged at different sides or edges of the first illumination unit;
are arranged at four sides or edges of the first illumination unit or circularly around the first illumination unit;
extend in a direction parallel to the surface of the composite part;
or any combination thereof.

7. The system according to claim 1, further comprising:
a beam splitter unit,
wherein the polarization camera unit comprises a matrix polarization camera, and
wherein the beam splitter unit comprises or is configured as a non-polarizing, semi-transparent beam splitter.

8. The system according to claim 1, wherein the first illumination unit, the second illumination unit or both are configured to generate amber light.

9. The system according to claim 1, wherein the processor unit is configured to classify the defects according to a criticality, or to generate a link from an image of the defects to a physical location of each defect, or both.

10. A method for surface inspection of a composite part of an aircraft, the method comprising:
alternately illuminating a surface of a composite part to be inspected with evenly distributed light generated by a first illumination unit and with light hitting the surface at an angle from different sides generated by a second illumination unit;
generating image data of the surface with a polarization camera unit while the surface is alternately illuminated by the first illumination unit and by the second illumination unit; and
processing the image data by a processor unit which detects defects on the surface of the composite part and determines directions of fibers within the composite part from the image data.

11. The method according to claim 10, wherein the polarization camera unit captures images of the surface of the composite part through a viewing window provided in the second illumination unit and via a beam splitter unit arranged between the viewing window and a top area light source of the first illumination unit.

12. The method according to claim 11, wherein the viewing window is provided in a base area light source of the first illumination unit.

13. The method according to claim 12, wherein the top area light source is arranged behind the viewing window so that the base area light source and the top area light source together completely cover the surface to be inspected with the evenly distributed light.

14. The method according to claim 10, wherein the surface to be inspected within a field of view of the polarization camera unit is completely covered by a light emitting area which is formed by the first illumination unit and frontally illuminating the surface.

15. The method according to claim 10, wherein the processor unit classifies the defects on the surface of the composite part according to a criticality and generates links from the image data to physical locations of the defects.

16. The method according to claim 10, wherein the processor unit determines the directions of the fibers within the composite part by analyzing polarization directions of the light hitting the surface at an angle from different sides and reflected to the polarization camera unit.
